(19) United States
(12) Patent Application Publication
(10) Pub. No.: US 2013/0153082 A1
(43) Pub. Date: Jun. 20, 2013

(54) VARIABLE FRICTION TIRES

(71) Applicants: TIMOTHY M. LYNAR, CARLTON VIC (AU); KENT C. STEER, CARLTON VIC (AU)

(72) Inventors: TIMOTHY M. LYNAR, CARLTON VIC (AU); KENT C. STEER, CARLTON VIC (AU)

(73) Assignee: INTERNATIONAL BUSINESS MACHINES CORPORATION, Armonk, NY (US)

(21) Appl. No.: 13/325,465

(22) Filed: Dec. 14, 2011

(51) Int. Cl. B65B 31/00; B60C 5/22

(52) U.S. Cl. 141/1; 152/339.1

(57) ABSTRACT

A variable friction tire is provided. The variable friction tire includes a tire wall portion, a tread portion, a primary inflatable tube, and a secondary inflatable tube. The tread portion is for contacting the ground. The primary inflatable tube is at least partially encapsulated by the tire wall portion. The secondary inflatable tube is disposed between at least a portion of the tread portion and at least a portion of the primary inflatable tube. The secondary inflatable tube is selectively inflatable or deflatable in order to vary an amount of the tread portion in contact with the ground.

### BACKGROUND

1. Technical Field

The present invention relates generally to tires and, in particular, to variable friction tires.

2. Description of the Related Art

Currently tires are designed for durability, grip, and to minimize stopping distance. However, given the prevalent use of tires and their direct as well as incidental effect on the environment, other concerns should also be considered in tire design.

### SUMMARY

According to an aspect of the present principles, a variable friction tire is provided. The variable friction tire includes a tire wall portion, a tread portion, a primary inflatable tube, and a secondary inflatable tube. The tread portion is for contacting the ground. The primary inflatable tube is at least partially encapsulated by the tire wall portion. The secondary inflatable tube is disposed between at least a portion of the tread portion and at least a portion of the primary inflatable tube. The secondary inflatable tube is selectively inflatable or deflatable in order to vary an amount of the tread portion in contact with the ground.

According to another aspect of the present principles, there is provided a method. The method includes providing a variable friction tire having a tire wall portion, a tread portion for contacting the ground, a primary inflatable tube at least partially encapsulated by the tire wall portion, and a secondary inflatable tube disposed between at least a portion of the tread portion and at least a portion of the primary inflatable tube. The method further includes selectively inflating or deflating the secondary inflatable tube in order to vary an amount of the tread portion in contact with the ground.

According to still another aspect of the present principles, there is provided a variable friction tire system. The system includes at least one variable friction tire having a tire wall portion, a tread portion for contacting the ground, a primary inflatable tube at least partially encapsulated by the tire wall portion, and a secondary inflatable tube disposed between at least a portion of the tread portion and at least a portion of the primary inflatable tube. The secondary inflatable tube is selectively inflatable or deflatable in order to vary an amount of the tread portion in contact with the ground. The system further includes a secondary inflatable tube pressure control valve for connecting to an air source. The system also includes an air supply line having a first end and a second end. The first end is connected to the secondary inflatable tube and the second end is connected to the secondary inflatable tube pressure control valve. The system additionally includes a control unit, connected to the secondary inflatable tube pressure control valve, for receiving current vehicle status information and controlling a pressure supplied to the secondary inflatable tube through the secondary inflatable tube pressure control valve based on the current vehicle status information.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary variable friction tire 100 having a primary tube 110, a secondary tube 120, a tread portion 130, and a tire wall portion 140, with the secondary tube 120 in a deflated state, in accordance with an embodiment of the present principles;

FIG. 2 shows the variable friction tire 100 of FIG. 1 with the secondary tube 120 in an inflated state, in accordance with an embodiment of the present principles;

FIG. 3 shows the variable friction tire 100 of FIG. 1, having a center tread portion 333 of a different material than the majority of the tread portion 130, in accordance with an embodiment of the present principles;

FIG. 4 shows an exemplary model 400 of the variable friction tire 100, with the secondary tube 120 in a deflated state, in accordance with an embodiment of the present principles;

FIG. 5 shows the model 400 of FIG. 4, with the secondary tube 120 in an inflated state, in accordance with an embodiment of the present principles;

FIG. 6 shows an exemplary variable friction tire system 600, in accordance with an embodiment of the present principles;

FIG. 7 shows a side view 710 of a variable friction tire 100 in relation to a front view 750 of the variable friction tire 100, in accordance with an embodiment of the present principles; and

FIG. 8 shows an exemplary method 800 for using a variable friction tire, in accordance with an embodiment of the present principles.

### DETAILED DESCRIPTION OF PREFERRED EMBODIMENTS

The present principles are directed to variable friction tires.

As noted above, currently tires are designed for durability, grip, and to minimize stopping distance. Advantageously, the present principles provide variable friction tires that can minimize stopping distance and reduce friction. Variable friction tires in accordance with the present principles can be considered smart tires given their automatic adaptability as described in further detail herein. In an embodiment, friction with the road is decreased, when appropriate, which results in reduced fuel consumption and reduced CO₂ emissions without compromising safety.

We note that cars do not always need as much contact area with the ground as they do for general around the town driving, or for stopping. The idea is to create tires that have the ability to alter their area of contact with the ground based on the needs of the car. When the car is driving on the freeway, pressure in a secondary tube could be increased and the contact surface could become smaller and harder so as to reduce friction and save fuel consumption. When the car moves in a direction other than the intended direction (as evidenced by a comparison of current vehicle direction versus steering wheel position) of the driver or the driver desires to decelerate, the electronic stability program in the car could interface with the tire to reduce pressure and increase contact with the road by providing a higher friction surface.

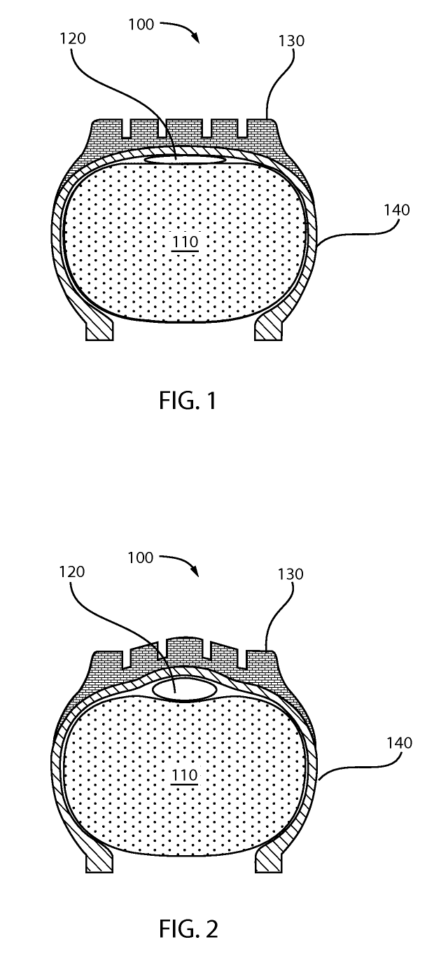

FIG. 1 shows an exemplary variable friction tire 100 having a primary inflatable tube (also interchangeably referred to herein as the “primary tube” in short) 110, a secondary inflatable tube (also interchangeably referred to herein as the “secondary tube” in short) 120, a tread portion 130, and a tire wall portion 140, with the secondary tube 120 in a deflated state, in accordance with an embodiment of the present principles. FIG. 2 shows the variable friction tire 100 of FIG. 1 with the secondary tube 120 in an inflated state, in accordance with an embodiment of the present principles.

The pressure in the primary tube 110 is kept relatively constant during use. The pressure in the secondary tube 120 can be varied while driving in accordance with the teachings of the present principles. For example, decreasing the pressure (see FIG. 1) in the secondary tube 120 results in an increased tread surface area contacting the road. Conversely, increasing the pressure (see FIG. 2) in the secondary tube 120 results in a decreased tread surface area contacting the road.

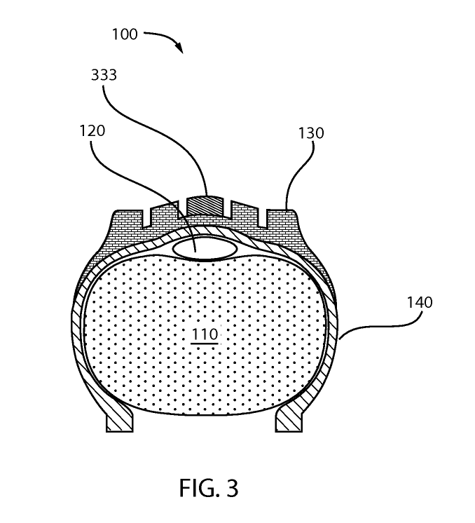

FIG. 3 shows the variable friction tire 100 of FIG. 1, having a center tread portion 333 of a different material than the majority of the tread portion 130, in accordance with an embodiment of the present principles. In the embodiment of FIG. 3, the portion (center portion 333 of the tread portion 130) of the tire 100 which is in contact with the road when the secondary tube 120 is inflated is made of a material which is more durable and has lower friction than the majority of the tread portion 130.

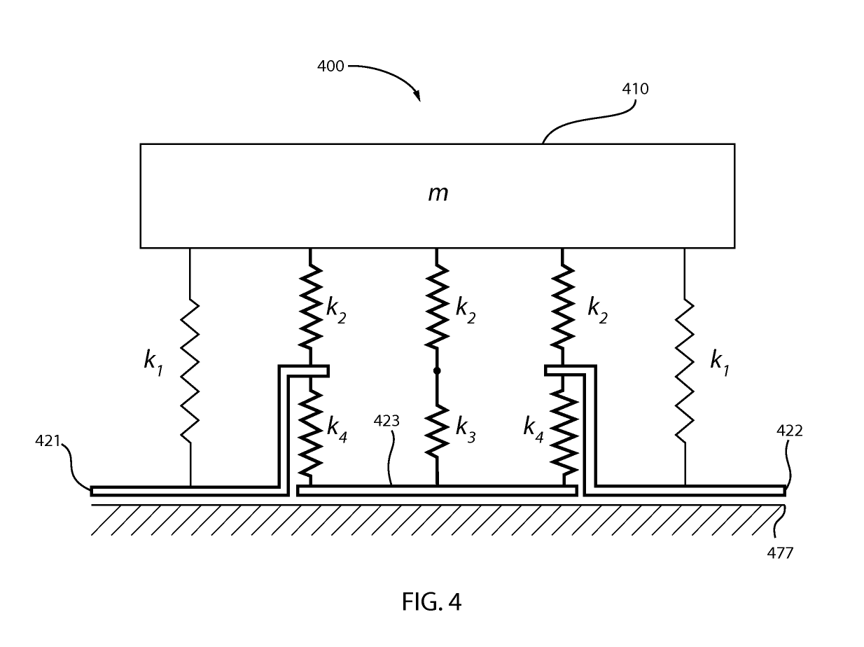

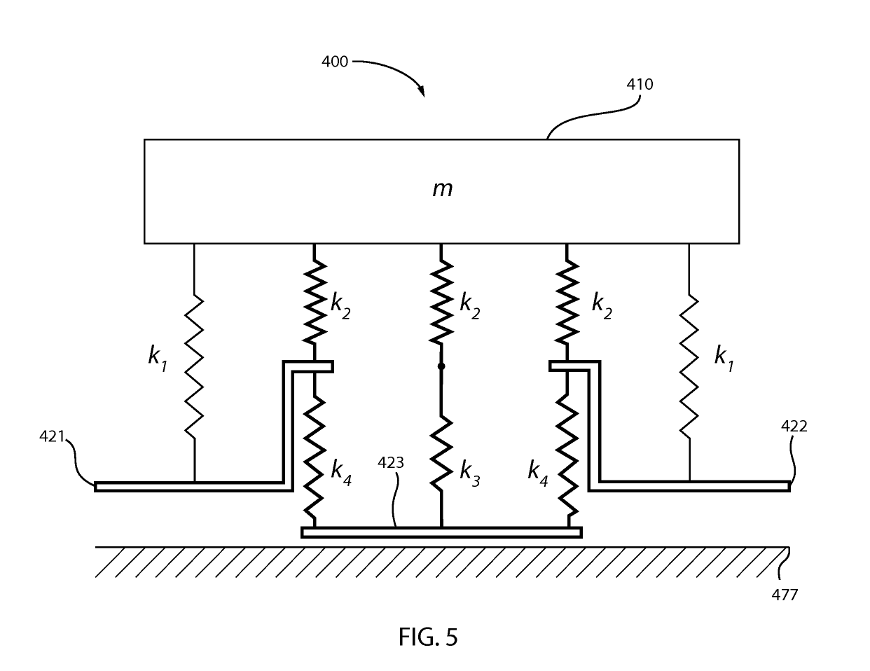

FIG. 4 shows an exemplary model 400 of the variable friction tire 100, with the secondary tube 120 in a deflated state, in accordance with an embodiment of the present principles. FIG. 5 shows the model 400 of FIG. 4, with the secondary tube 120 in an inflated state, in accordance with an embodiment of the present principles.

The large upper block (labeled “m” as well as indicated by the reference numeral 410) represents the mass resting on the tire 100. The variable friction tire is shown in the steady state and, thus, dampers, vehicle shock absorbers, and the like are omitted from FIGS. 4 and 5 for the sake of brevity and simplicity. The ground is indicated by the reference numeral 477.

The three solid black lines 421, 422, and 423 represent tread segments as discrete, massless, rigid bodies connected by springs having a spring constant of k₄ (with each of such springs being hereinafter simply referred to as “spring k₄”). Note that the depicted shapes are not representative of physical form but rather are abstractions which capture the manner in which the components interact.

The tire walls 140, which interact with the tread portion 130 and the wheel hub, are each represented as a spring having a spring constant of k₁ (with each of such springs being hereinafter simply referred to as “spring k₁”). In FIGS. 4 and 5, the tire wall 140 is in tension.

Three springs having a spring constant of k₂ (with each of such springs being hereinafter simply referred to as “spring k₂”) represent the primary tube 110. The three springs k₂ capture the distributed contact area between the primary tube 110 and the tread portion 130. A spring having a spring constant of k₃ (with such spring being hereinafter simply referred to as “spring k₃”) represent the primary tube 120.

The spring constant of a flexible pressure vessel is proportional to the pressure in the primary tube 110. Hence, the spring constant for the primary tube 110 is as follows: k₂ ∝ Pₚ. Similarly, the spring constant for the secondary tube 120 is as follows: k₃ ∝ Pₛ. However, the secondary tube 120 is smaller than the primary tube 110 and only exerts influence on the central tread segment 333.

Another relevant relation is given by Hooke's law: F=−kx, where F is the force exerted by a spring, k is the spring constant, and x is the positive elongation of the spring relative to the equilibrium point.

To combine two springs in series we compute a new spring constant as follows:

$$\frac{1}{{k}_{c}} = \frac{1}{{k}_{1}} + \frac{1}{{k}_{2}} \qquad ( 1 )$$

As Pₛ increases so does k3 and by Hooke's law the force supported by the central tread 333 increases. It follows that the force on the outer tread segments decreases and again by Hooke's law the elongation of the springs attached to the outer tread segments decreases reducing their contact with the road (see FIG. 5).

We list here three possible embodiments for the mechanism by which the secondary tube 120 remains in the correct location as follows: (1) molded, where the two tubes are created together; (2) glued, where the tubes are created separately and glued together; and (3) channeled, where the tire is constructed with a channel which holds the secondary tube 120 in position. Of course, other mechanisms may also be used to maintain the secondary tube 120 in the correct location, as readily determined by one of ordinary skill in the art, given the teachings of the present principles provided herein.

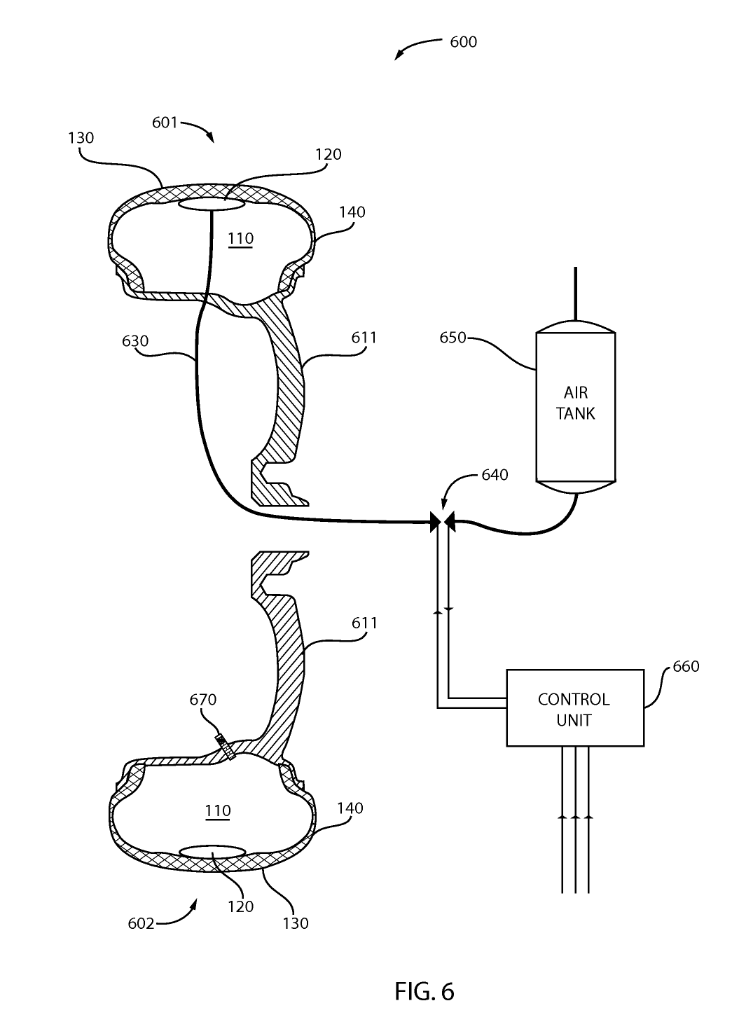

FIG. 6 shows an exemplary variable friction tire system 600, in accordance with an embodiment of the present principles. For the sake of illustration, 2 tires are shown. The tires 601 and 602 are attached to respective wheel hubs 611 and 612. While further details of the system 600 with respect to tire 601, the same apply to tire 602 but may be omitted for the sake of brevity.

An air supply line 630 is connected to the secondary tube 120 on one end and to a secondary tube pressure control valve 640 on the other end. The air supply line 630 is flexible and runs through a molded hole in the primary tube 110. The valve 640 is connected to an air tank 650 that, in turn, is connected to an air compressor (not shown). Operation of the valve 640 is controlled by a control unit 660 that receives information on the current vehicle state uses the information to manage the pressure in the secondary tube 120. The control unit 660 takes one or more of the following as inputs: velocity; braking; and wheel slip. Braking can include any of whether the brake pedal is simply being depressed or not, or can include an amount of depression or some other indictor of actual braking force. Other inputs can also be used, such as steering inputs (e.g., an amount by which the steering is wheel is turned from a center position) and so forth. Of course, the preceding inputs are merely illustrative and, thus, other inputs may be supplied to the control unit 660 as readily determined by one of ordinary skill in the art, given the teachings of the present principles provided herein.

The control unit 660 will hold the valve 640 open and allow the pressure in the secondary tube 120 to reach that of the air tank 650 if: (1) the velocity is above a certain threshold; (2) the brake is not being applied; and (3) the wheels are not slipping. Otherwise, the valve 640 will remain open to atmospheric pressure and the secondary tube 120 will deflate. The pressure in the air tank 650 may also vary with the velocity to enable a smooth transition between low friction and high friction driving modes.

In an embodiment relating to FIG. 6, the pressure in the primary tube 110 is not dynamically adjusted during driving. Thus, for example, regarding tire 601, the primary tube valve 670 is located diametrically opposite the outlet of the air supply line 630 to avoid weakening the wheel hub 611. Of course, in other embodiments, the pressure in the primary tube 110 can also be dynamically adjusted during driving similar to the secondary tube 120.

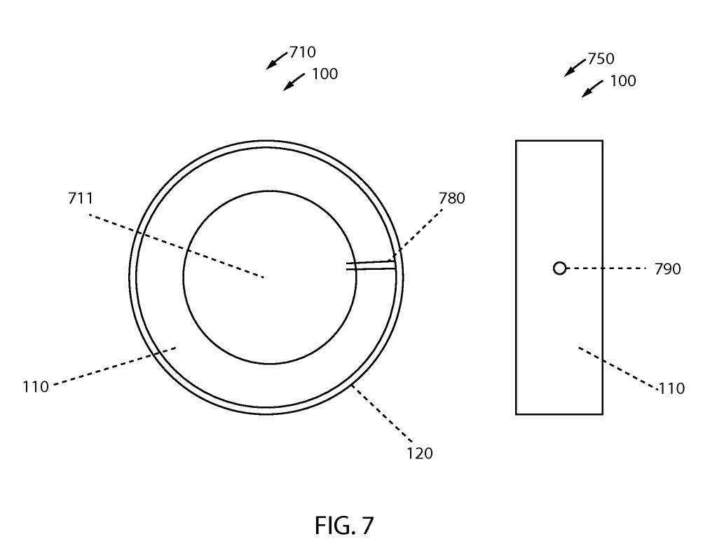

FIG. 7 shows a side view 710 of a variable friction tire 100 in relation to a front view 750 of the variable friction tire 100, in accordance with an embodiment of the present principles.

Hence, air can move from the hub 711 to the primary tube 110. An air tube 780, that is part of the primary tube 110, extrudes through a molded hole 790 in the primary tube 110.

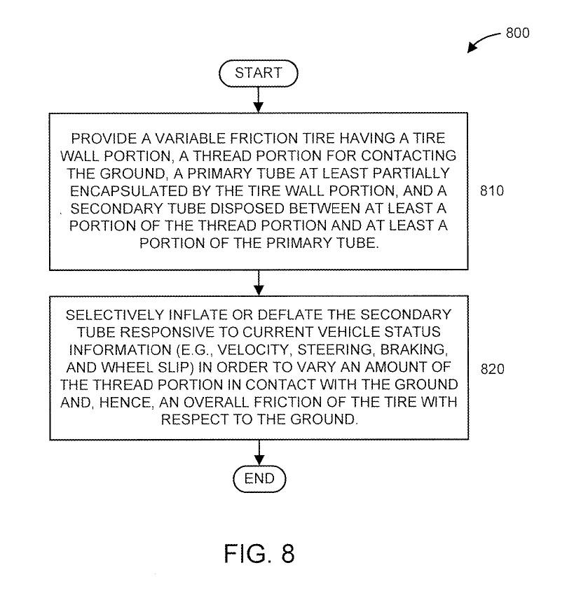

FIG. 8 shows an exemplary method 800 for using a variable friction tire, in accordance with an embodiment of the present principles.

At step 810, a variable friction tire is provided having a tire wall portion, a tread portion for contacting the ground, a primary tube at least partially encapsulated by the tire wall portion, and a secondary tube disposed between at least a portion of the tread portion and at least a portion of the primary tube.

At step 820, the secondary tube is selectively inflated or deflated responsive to current vehicle status information (e.g., velocity, steering, braking, and wheel slip) in order to vary an amount of the tread portion in contact with the ground and, hence, an overall friction of the tire with respect to the ground.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A variable friction tire, comprising:
a tire wall portion;
a tread portion for contacting the ground;
a primary inflatable tube at least partially encapsulated by the tire wall portion; and
a secondary inflatable tube disposed between at least a portion of the tread portion and at least a portion of the primary inflatable tube,
wherein the secondary inflatable tube is selectively inflatable or deflatable in order to vary an amount of the tread portion in contact with the ground.

2. The variable friction tire of claim 1, wherein varying the amount of the tread portion in contact with the ground correspondingly varies an overall friction of the tire with respect to the ground.

3. The variable friction tire of claim 1, wherein a center portion of the tread portion is constructed to be harder and more durable than remaining portions of the tread portion.

4. The variable friction tire of claim 1, wherein an intended location of the secondary inflatable tube is maintained by any one of molding the primary inflatable tube and the secondary inflatable tube together, creating the primary inflatable tube and the secondary inflatable tube separately and gluing the primary inflatable tube and the secondary inflatable tube together, and forming the secondary inflatable tube within a channel in one or more of the tread portion and the primary inflatable tube.

5. The variable friction tire of claim 1, wherein the primary inflatable tube comprises an air supply passing aperture for allowing an air supply line to pass there through, and wherein the secondary inflatable tube comprises a connection for connecting to the air supply line.

6. The variable friction tire of claim 1, wherein the secondary inflatable tube comprises a valve for venting the secondary inflatable tube to atmospheric pressure.

7. A method, comprising:
providing a variable friction tire having a tire wall portion, a tread portion for contacting the ground, a primary inflatable tube at least partially encapsulated by the tire wall portion, and a secondary inflatable tube disposed between at least a portion of the tread portion and at least a portion of the primary inflatable tube; and
selectively inflating or deflating the secondary inflatable tube in order to vary an amount of the tread portion in contact with the ground.

8. The method of claim 7, wherein varying the amount of the tread portion in contact with the ground correspondingly varies an overall friction of the tire with respect to the ground.

9. The method of claim 7, wherein the secondary inflatable tube is selectively inflated or deflated responsive to current vehicle status information.

10. The method of claim 9, wherein the current vehicle status information comprises one or more of velocity, steering, braking, and wheel slip.

11. The method of claim 7, wherein the secondary inflatable tube is selectively inflated or deflated while a corresponding vehicle on which the variable friction tire is mounted is in motion.

12. The method of claim 7, wherein the secondary inflatable tube is selectively inflated when a corresponding vehicle on which the variable friction tire is mounted is moving above a given threshold velocity so as to decrease the amount of the tread portion in contact with the ground.

13. The method of claim 7, wherein the secondary inflatable tube is selectively inflated when a corresponding vehicle on which the variable friction tire is mounted is moving above a given threshold velocity and within a threshold direction variation range so as to decrease the amount of the tread portion in contact with the ground.

14. The method of claim 7, wherein the secondary inflatable tube is selectively deflated when a corresponding vehicle on which the variable friction tire is mounted is moving in an unintended direction so as to increase the amount of the tread portion in contact with the ground.

15. A variable friction tire system, comprising:
at least one variable friction tire, having a tire wall portion, a tread portion for contacting the ground, a primary inflatable tube at least partially encapsulated by the tire wall portion, and a secondary inflatable tube disposed between at least a portion of the tread portion and at least a portion of the primary inflatable tube, the secondary inflatable tube being selectively inflatable or deflatable in order to vary an amount of the tread portion in contact with the ground;
a secondary inflatable tube pressure control valve for connecting to an air source;
an air supply line having a first end and a second end, the first end connected to the secondary inflatable tube and the second end connected to the secondary inflatable tube pressure control valve; and
a control unit, connected to the secondary inflatable tube pressure control valve, for receiving current vehicle status information and controlling a pressure supplied to the secondary inflatable tube through the secondary inflatable tube pressure control valve based on the current vehicle status information.

16. The variable friction tire system of claim 15, wherein varying the amount of the tread portion in contact with the ground correspondingly varies an overall friction of the tire with respect to the ground.

17. The variable friction tire system of claim 15, wherein a center portion of the tread portion is constructed to be harder and more durable than remaining portions of the tread portion.

18. The variable friction tire system of claim 15, wherein an intended location of the secondary inflatable tube is maintained by one of the following: molding the primary inflatable tube and the secondary inflatable tube together, creating the primary inflatable tube and the secondary inflatable tube separately and gluing the primary inflatable tube and the secondary inflatable tube together, and forming the secondary inflatable tube within a channel in one or more of the tread portion and the primary inflatable tube.

19. The variable friction tire system of claim 15, wherein the primary inflatable tube comprises an air supply passing aperture for allowing the air supply line to pass there through, and wherein the secondary inflatable tube comprises a connection for connecting to the air supply line.

20. The variable friction tire system of claim 15, wherein the secondary inflatable tube comprises a valve for venting the secondary inflatable tube to atmospheric pressure.

21. The variable friction tire system of claim 15, wherein the current vehicle status information comprises one or more of velocity, steering, braking, and wheel slip.

22. The variable friction tire system of claim 15, wherein the secondary inflatable tube is selectively inflated or deflated while a corresponding vehicle on which the variable friction tire is mounted is in motion.

23. The variable friction tire system of claim 15, wherein the air source is an air tank.

24. The variable friction tire system of claim 23, wherein the control unit is configured to hold the secondary inflatable tube pressure control valve open and allow a pressure in the secondary inflatable tube to reach that of the air source when a vehicle velocity is above a certain threshold, a vehicle braking system is not being applied, and there is an absence of tire slip.

25. The variable friction tire system of claim 15, wherein the control unit varies the pressure supplied to the secondary inflatable tube based on vehicle velocity to enable a smooth transition between low friction and high friction driving modes.
